(19) United States
(12) Patent Application Publication
(10) Pub. No.: US 2026/0068902 A1
(43) Pub. Date: Mar. 12, 2026

(54) BEVERAGE TABLET AND METHOD OF MANUFACTURING SAME

(71) Applicant: KEURIG GREEN MOUNTAIN, INC., Burlington, MA (US)

(72) Inventors: Matthew James Maille, Essex Junction, VT (US); James Lewis Davis, Cincinnati, OH (US); Patrick Donnelly, Ipswich, MA (US)

(73) Assignee: KEURIG GREEN MOUNTAIN, INC., Burlington, MA (US)

(21) Appl. No.: 19/133,469

(22) PCT Filed: Dec. 1, 2023
(86) PCT No.: PCT/US2023/082092

§ 371 Date: May 28, 2025

Related U.S. Application Data
(60) Provisional application No. 63/429,962, filed on Dec. 2, 2022.

(51) Int. Cl. A23F 5/12

(52) U.S. Cl. CPC A23F 5/125

(57) ABSTRACT

Aspects disclosed herein relate to beverage tablets for use in forming a beverage. The beverage tablets may have first and second portions having different concentrations of at least one beverage ingredient. In some embodiments, a beverage tablet may be formed to have an inner portion surrounded by an outer portion. In some embodiments, a beverage tablet may be formed to have a layered arrangement.

### CROSS REFERENCE TO RELATED APPLICATION

This application claims the benefit of U.S. Provisional Application No. 63/429,962, filed Dec. 2, 2022, which is hereby incorporated by reference in its entirety.

### FIELD

Disclosed embodiments are directed to beverage tablets for use in forming beverages and methods of manufacturing such beverage tablets.

### BACKGROUND

Tablets of compacted beverage ingredients can be used for forming a beverage. In some arrangements, such beverage tablets are mixed directly with hot water to form a beverage. In some arrangements, water is permitted to percolate through beverage tablets to form a beverage.

### SUMMARY

According to one aspect, in some embodiments, a beverage tablet for use in forming a beverage may comprise an inner portion comprising a first ingredient comprising coffee. The inner portion may have a boundary. The beverage table may have an outer portion surrounding at least a majority of the boundary of the inner portion. The outer portion may comprise a second ingredient comprising coffee. The first ingredient may have a roast level different from the roast level of the second ingredient.

For example, in some embodiments, the outer portion of the beverage tablet may fully surround the boundary of the inner portion. In some embodiments, the roast level of the first ingredient in the inner portion may have a lighter roast level than the roast level of the second ingredient in the outer portion. In some embodiments, the tensile strength of the inner portion may be different than a tensile strength of the outer portion, e.g., the tensile strength of the inner portion may be higher than the tensile strength of the outer portion. In some embodiments, during a formation of the beverage tablet, the first ingredient and the second ingredient may be co-compressed. In some embodiments, the outer portion of the beverage tablet may be configured to delaminate from the inner portion in response to a diametral compression force. In some embodiments, the inner portion of the beverage tablet may further comprise a binding agent, where a concentration of the binding agent in the inner portion is greater than a concentration of the binding agent in the outer portion. In some embodiments, the binding agent may include cellulose. In some embodiments, the outer portion of the beverage tablet may further comprise a filter aid, and a concentration of a filter aid in the outer portion may be greater than a concentration of the filter aid in the inner portion. In some embodiments, the filter aid may include cellulose. In some embodiments, the beverage tablet may further comprise a second inner portion with a boundary, where the outer portion of the beverage surrounds at least a majority of the boundary of the second inner portion, and the second inner portion is nested within the inner portion. In some embodiments, the second inner portion may be spaced from the inner portion. In some embodiments, the beverage tablet may comprise an outer wall having a shape with a finite order of rotational symmetry. For example, the outer wall may be non-circular or oval-shaped. In some embodiments, the outer wall may have a circular shape.

According to another aspect, in some embodiments, a beverage tablet for use in forming a beverage may comprise a first portion made of one or more beverage ingredients, and a second portion made of one or more beverage ingredients, where a concentration of a filter aid is greater in the second portion than in the first portion.

For example, in some embodiments, the first portion of the beverage tablet may comprise coffee. In some embodiments, the filter aid may comprise at least one of perlite, diatomaceous earth, and cellulose. In some embodiments, the first portion and/or the second portion may span across at least a majority of a width of the beverage tablet. In some embodiments, the first portion of the beverage tablet may be adjacent the second portion of the beverage tablet. In some embodiments, a beverage tablet may further include an interface between the first portion and the second portion. In some embodiments, the first portion may comprise an inner portion having a boundary, and the second portion may comprise an outer portion surrounding at least a majority of the boundary of the inner portion. Tn some embodiments, the outer portion may fully surround the boundary of the inner portion. In some embodiments, the beverage tablet may include a second inner portion having a boundary, where the outer portion of the beverage tablet surrounds at least a majority of the boundary of the second inner portion, and where the second inner portion is nested within the inner portion. In some embodiments, the second inner portion may be spaced from the inner portion. In some embodiments, the first portion of the beverage tablet may be arranged in a first layer, and the second portion may be arranged in a second layer. In some embodiments, the first layer may be stacked on the second layer. In some embodiments, during a formation of the beverage tablet, the first portion and the second portion may be co-compressed. In some embodiments, the beverage tablet may comprise an outer wall having a shape with a finite order of rotational symmetry. For example, the outer wall may be non-circular or oval-shaped. In some embodiments, the outer wall may have a circular shape.

According to yet another aspect, in some embodiments, a beverage tablet for use in forming a beverage may comprise a first portion made of one or more beverage ingredients and a second portion made of one or more beverage ingredients, where a concentration of a binding agent is greater in the first portion than in the second portion.

In some embodiments, the binding agent may comprise at least one of cellulose, cellulose derivatives, gelatin, starch, sucrose, mannitol, liquid glucose, and zein. In some embodiments, the second portion of the beverage tablet may comprise coffee. In some embodiments, the first and/or second portion may span across at least a majority of a width of the beverage tablet. In some embodiments, the first portion may be adjacent the second portion. In some embodiments, a beverage tablet may comprise an interface between the first portion and the second portion. In some embodiments, the first portion may comprise an inner portion having a boundary, and the second portion may comprise an outer portion surrounding at least a majority of the boundary of the inner portion. In some embodiments, the outer portion may fully surround the boundary of the inner portion. In some embodiments, the beverage tablet may comprise a second inner portion having a boundary, where the outer portion surrounds at least a majority of the boundary of the second inner portion, and where the second inner portion is nested within the inner portion. In some embodiments, the second inner portion may be spaced from the inner portion. In some embodiments, during a formation of the beverage tablet, the first and second portions may be co-compressed. In some embodiments, in response to a diametral compression force, the first portion may be configured to delaminate from the second portion. In some embodiments, the first portion may be arranged in a first layer and the second portion may be arranged in a second layer. In some embodiments, the first layer may be stacked on the second layer. In some embodiments, the beverage tablet may comprise an outer wall having a shape with a finite order of rotational symmetry. For example, the outer wall may be non-circular or oval-shaped. In some embodiments, the outer wall may have a circular shape.

According to yet another aspect, in some embodiments, the beverage tablet may be manufactured through a method with steps comprising introducing a first beverage ingredient into a die cavity, introducing a second beverage ingredient into the die cavity, and then compressing the first and second beverage ingredients together within the die cavity such that the first and second beverage ingredients are co-compressed.

In some embodiments, the step of compressing the first and second beverage ingredients together may result in formation of an inner portion and an outer portion of the beverage tablet, wherein the inner portion comprises the first beverage ingredient and the outer portion comprises the second beverage ingredient, with the outer portion surrounding at least a majority of a boundary of the inner portion. In some embodiments, the outer portion may fully surround the boundary of the inner portion. In some embodiments, the step of compressing the first and second beverage ingredients together may result in formation of a first layer and a second layer of the beverage tablet, where the first layer comprises the first beverage ingredient and the second layer comprises the second beverage ingredient.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

FIG. 1A is embodiment of a beverage tablet with an inner portion and an outer portion;

FIG. 1B is a perspective cross-sectional view of the beverage tablet of FIG. 1A;

FIG. 2A is another embodiment of a beverage tablet with an inner portion and an outer portion;

FIG. 2B is a perspective cross-sectional view of the beverage tablet of FIG. 2A;

FIG. 3A is another embodiment of a beverage tablet with an outer portion and a plurality of inner portions;

FIG. 3B is a perspective cross-sectional view of the beverage tablet of FIG. 3A;

FIG. 4A is another embodiment of a beverage tablet with an outer portion and a plurality of inner portions;

FIG. 4B is a perspective cross-sectional view of the beverage tablet of FIG. 4A;

FIG. 5A is another embodiment of a beverage tablet with an outer portion and a plurality of inner portions;

FIG. 5B is a perspective cross-sectional view of the beverage tablet of FIG. 5A;

FIG. 6A is another embodiment of a beverage tablet with a layered structure comprising two layers;

FIG. 6B is a perspective cross-sectional view of the beverage tablet of FIG. 6A;

FIG. 7A is another embodiment of a beverage tablet with a layered structure having three layers;

FIG. 7B is a perspective cross-sectional view of the beverage tablet of FIG. 7A;

FIG. 8A shows a beverage tablet prior to being subjected to a diametral compression force by a machine; and

FIG. 8B shows the beverage tablet of FIG. 8A being broken into multiple pieces during diametral compression.

### DETAILED DESCRIPTION

It should be understood that aspects of the invention are described herein with reference to the figures, which show illustrative embodiments. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

It is well known to provide beverage material into individual consumable portions of single servings or small batch servings. Such consumables are commonly provided in individual packages and used with associated beverage machines to form a beverage.

These beverage machines and consumables may allow a user to prepare a small quantity of a beverage, such as a single serving. Multiple users can use the same machine to prepare different beverages, such as individual servings of different beverage types or beverage flavors quickly and without wasting unconsumed beverage. Single serving or small batch beverage machines may receive individual serving packages of beverage material, such as ground coffee, to be combined with liquid and brewed. These individual packages of beverage material may then be disposed after the beverage has been prepared.

The inventors have recognized and appreciated improvements in beverage material packaging, beverages machines, and methods of forming a beverage. These improvements may reduce beverage material packaging and/or waste resulting from the preparation of a beverage. According to embodiments disclosed herein, beverage material may be portioned for use within a beverage machine without separate disposable packaging for each portion.

According to aspects discussed herein, a beverage ingredient consumable may be provided in the form of a beverage tablet. In some embodiments, the beverage ingredients of the beverage tablet have been compacted to form the tablet. The beverage tablet may be able to hold its own shape, and thus may not require individual packaging to prevent dispersing of the beverage material prior to use in forming a beverage.

A beverage tablet may be used to form a beverage such as tea, coffee, espresso, cocoa or other beverages prepared from a powder, dry concentrate or dry beverage material such as suitably prepared coffee beans, tea leaves etc. The beverage machine may form such beverages using a base liquid, such as water, that may be combined with the beverage material under suitable conditions to form the beverage.

In some embodiments, a beverage tablet may have a body and an outer wall, where the body and/or the outer wall are made of one or more beverage ingredients. Examples of beverage ingredients include, but are not limited to: coffee (e.g., coffee grounds, soluble coffee), tea (e.g. tea leaves, dry herbal tea), powdered beverage concentrate, dried fruit extract or powder, powdered or liquid concentrated bouillon or other soup, powdered or liquid medicinal materials (e.g. nutraceuticals), powdered milk or other creamers, sweeteners, thickeners, flavorings, binding agents, coating agents, cellulose, chaff, filter aids, extracts, plant husks, plant fibers, bagasse, additives, or any other type of food.

In some embodiments, one or more portions of a tablet may comprise a filter aid. The inventors have appreciated that, in some embodiments, a filter aid in a compacted beverage tablet may serve as an initial filtration system, wherein the filter aid may filter out a portion of unwanted material. If a beverage machine is used to form a beverage from the beverage tablet, the filter aid may serve to reduce clogging in the beverage machine. In some embodiments, a filter aid in a beverage tablet may help to extend the lifetime of one or more components of a beverage machine, such as a beverage machine filter. Examples of filter aids include, but are not limited to, perlite, diatomaceous earth, diatomite, chaff, and cellulose.

The inventors have also appreciated that, in some embodiments, a filter aid may increase a porosity of a beverage tablet, which may enhance extraction efficiency from the beverage tablet during the brewing process. In some situations, a filter aid may reduce the need for a beverage tablet to be pasteurized or treated with a preservation process before extended storage, and may decrease the risk of spoilage.

In some embodiments, one or more portions of a tablet may comprise a binding agent. Examples of binding agents include, but are not limited to, cellulose, cellulose derivatives, gelatin, cream, honey, starch, sucrose, mannitol, liquid glucose, and zein.

The inventors have recognized that conventional compacted coffee beverage tablets have low tensile strength and can break easily, leading to issues during storage and transportation. While the inventors have appreciated that tablets may, in some embodiments, be intentionally broken during a beverage formation process, the inventors have recognized that it may be beneficial to avoid unintentional breakage of a tablet during transport and storage. For example, in some cases, a broken beverage tablet may lose taste and freshness over time.

According to one aspect, the inventors have appreciated that positioning certain ingredients in specific areas of the tablet may provide beneficial outcomes. For example, such positioning may influence the strength of the tablet, the breakage profile of the tablet, the taste of a beverage formed from the tablet, the texture of a beverage formed from the tablet, and/or the flavor profile of a beverage formed from the tablet. It should be appreciated that such benefits are illustrative examples, and one or more of these effects may not necessarily apply in all situations.

The inventors have appreciated that, in some situations, compacted coffee tablets made of light roast coffee may have low tensile strength. Although in some embodiments, low tensile strength may be desired, in other embodiments, low tensile strength may not be desirable. The inventors have recognized that, in some situations, compacted coffees with darker roasts may have increased tensile strength compared to compacted coffees with lighter roasts. The inventors found that positioning a lighter roast coffee in a first portion of a tablet and positioning a darker roast coffee in a second portion of a tablet may help to increase the overall tensile strength of the tablet compared to a tablet made only of the lighter roast coffee. As a result, the increased tensile strength may prevent the beverage tablet from breaking prematurely, such as during transit or storage of the beverage tablet. In some embodiments, adjusting the ratio of the lighter roast coffee to the darker roast coffee may serve to control the flavor profile of the beverage formed from the tablet. In some embodiments, the beverage tablet may have a higher volume of light roast coffee than dark roast coffee, which may allow the beverage tablet to maintain the taste of a light roast coffee while having a greater tensile strength than a tablet formed only of light roast coffee. In some embodiments, a lighter roast coffee is positioned in an inner portion of a tablet, and a darker roast coffee is positioned in an outer portion of a tablet, or vice versa.

In some embodiments, as a result of positioning certain ingredients in specific areas of the tablet, the concentration of at least one beverage ingredient in a first portion of the beverage tablet may be different from the concentration of the beverage ingredient in a second portion of the beverage tablet. In some embodiments, the concentration of a beverage ingredient may be greater in a first portion than in a second portion, or vice versa. In some embodiments, a beverage ingredient may be present only in a first portion, and not in a second portion, or vice versa. As an example, a beverage tablet may have a different concentration of a binding agent, filter aid and/or type of coffee in a first portion of a beverage tablet compared to a second portion of a beverage tablet. In some embodiments, a first portion of a beverage tablet comprises a coffee having a roast level that is different from a roast level of a second portion of a beverage tablet. In some embodiments, the roast level of the coffee in the first portion may be darker than the roast level of the coffee in the second portion, or vice versa.

In one illustrative example, a beverage tablet may have a first portion comprising an inner portion, and a second portion comprising an outer portion. In some embodiments, the concentration of a beverage ingredient may be greater in an outer portion than in the inner portion, or vice versa. In some embodiments, a beverage ingredient may be present only in an inner portion, and not in an outer portion, or vice versa. As an example, a beverage tablet may have a different concentration of a binding agent, filter aid and/or type of coffee in an inner portion of a beverage tablet compared to an outer portion of a beverage tablet. In some embodiments, an inner portion of a beverage tablet comprises a coffee having a roast level that is different from a roast level of an outer portion of a beverage tablet. In some embodiments, the roast level of the coffee in the outer portion may be darker than the roast level of the coffee in the inner portion, or vice versa. In some embodiments, a beverage tablet may have a plurality of inner portions.

In another illustrative example, a beverage tablet may have a first portion comprising a first layer, and a second portion comprising a second layer. In some embodiments, the concentration of a beverage ingredient may be greater in the first layer than in the second layer, or vice versa. In some embodiments, a beverage ingredient may be present only in the first layer and not the second layer, or vice versa. As an example, a beverage tablet may have a different concentration of a binding agent, filter aid and/or type of coffee in a first layer of a beverage tablet compared to a second of a beverage tablet. In some embodiments, a first layer of a beverage tablet comprises a coffee having a roast level that is different from a roast level of a second layer of a beverage tablet. In some embodiments, the roast level of the coffee in the first layer may be darker than the roast level of the coffee in the second layer, or vice versa.

In some embodiments, a beverage tablet may have more than two layers. For example, in some embodiments, a beverage tablet may have two outer layers and an inner layer sandwiched between the two outer layers.

In some embodiments, a beverage tablet may be configured such that a first portion of the tablet may have a different tensile strength than a second portion of the tablet. In some embodiments, the concentration of a beverage ingredient may be greater in the outer layers than in the inner layer, or vice versa. In some embodiments, a beverage ingredient may be present only in the outer layers and not the inner layer, or vice versa. As an example, a beverage tablet may have a different concentration of a binding agent, filter aid and/or type of coffee in the outer layers of a beverage tablet compared to an inner layer of a beverage tablet. In some embodiments, the outer layers of a beverage tablet comprises a coffee having a roast level that is different from a roast level of an inner layer of a beverage tablet. In some embodiments, the roast level of the coffee in the outer layers may be darker than the roast level of the coffee in the inner layer, or vice versa. It should be appreciated that, in some embodiments, a beverage tablet may have more than three layers. In some embodiments, layers of similar beverage ingredients may be arranged in alternating fashion.

In some embodiments, a beverage tablet may have a first portion and a second portion, where the first portion has a beverage ingredient of a higher tensile strength than a beverage ingredient of the second portion. The resulting tablet may have higher tensile strength than a tablet formed only of the beverage ingredient with the lower tensile strength. In some embodiments, the ingredients of the first and second portions are co-compressed together to form the resulting tablet.

As one example, in some embodiments, a beverage tablet may have an inner portion and an outer portion, where the outer portion has a beverage ingredient of a higher tensile strength than a beverage ingredient of the inner portion. With the higher tensile strength ingredient encapsulating the lower tensile strength ingredient, the resulting tablet may have a higher tensile strength than a tablet formed only of the beverage ingredient with the lower tensile strength. In some embodiments, the ingredients of the inner and outer portions are co-compressed together to form the resulting tablet. In some embodiments, the beverage tablet may have multiple inner portions.

As another example, in some embodiments, a beverage tablet may have a first layer and a second layer, where the first layer has a beverage ingredient of a higher tensile strength than a beverage ingredient of the second layer. The resulting tablet may have higher tensile strength than a tablet formed only of the beverage ingredient with the lower tensile strength. In some embodiments, the ingredients of the first and second layers are co-compressed together to form the resulting tablet.

In some embodiments, the beverage tablet may have more than two layers. For example, in some embodiments, the beverage tablet may have two outer layers sandwiching an inner layer. The two outer layers may have a beverage ingredient of a higher tensile strength than a beverage ingredient of the inner layer, or vice versa. The resulting tablet may have higher tensile strength than a tablet formed only of the beverage ingredient with the lower tensile strength. In some embodiments, the ingredients of the inner and outer layers are co-compressed together to form the resulting tablet. In some embodiments, the beverage tablet may have more than three layers. In some embodiments, layers of similar beverage ingredients may be arranged in alternating fashion.

In some embodiments, the beverage tablet is used with a beverage machine to form a beverage. The beverage tablet may be configured to be received within a beverage machine without packaging such that the beverage ingredients of the beverage tablet directly contacts the beverage machine (e.g. a brew chamber) during a brewing process (e.g. without requiring the beverage machine to pierce through or otherwise open packaging to access the beverage ingredients).

In some embodiments, a package-less beverage consumable (e.g., a beverage tablet) may include a shell, such as a coating, disposed along the outer surface at the periphery of the consumable. In some embodiments, the shell may bind the beverage ingredients within the interior of the consumable. The beverage ingredients within the consumable may be loose, such as loose ground coffee, or compacted. The shell may be a food grade binder, an alginate, edible, soluble, or any other suitable material. In some embodiments, the shell may serve as a barrier to reduce infiltration of oxygen and/or moisture such as to maintain freshness of the beverage ingredients. Material of the package-less beverage consumable, including a shell of the consumable if one is present, may directly contact some portion of the beverage machine, such as the brew chamber, before brewing the beverage, without intervening packaging in-between.

A package-less beverage consumable (e.g., a beverage tablet) may be configured to break into pieces during brewing or it may be configured to remain intact during brewing. The package-less beverage consumable may be configured to at least partially or completely dissolve. In some embodiments, the package-less beverage consumable may contain roasted coffee grounds (e.g. that remain behind after forming a beverage), soluble coffee, soluble materials, binders or other materials, and any combination of the above. The package-less beverage consumable may be any suitable shape, such as a cylinder, a sphere, an ellipsoid, an elliptical prism, a teardrop shape, a frustrum of a cone, a cone or other shape.

A beverage tablet may be used to form a beverage such as tea, coffee, espresso, cocoa or other beverages prepared from a powder, dry concentrate or dry beverage material such as suitably prepared coffee beans, tea leaves etc. The beverage machine may form such beverages using a base liquid, such as water, that may be combined with the beverage material under suitable conditions to form the beverage.

In some embodiments, a beverage tablet may have a body and an outer wall, where the body and/or the outer wall are made of one or more beverage ingredients. Examples of beverage ingredients include, but are not limited to: coffee (e.g., coffee grounds, soluble coffee), tea (e.g. tea leaves, dry herbal tea), powdered beverage concentrate, dried fruit extract or powder, powdered or liquid concentrated bouillon or other soup, powdered or liquid medicinal materials (e.g. nutraceuticals), powdered milk or other creamers, sweeteners, thickeners, flavorings, binding agents, coating agents, cellulose, chaff, filter aids, extracts, plant husks, plant fibers, bagasse, additives, or any other type of food. Examples of filter aids include, but are not limited to, perlite, diatomaceous earth, diatomite, chaff, and cellulose. Examples of binding agents include, but are not limited to, cellulose, cellulose derivatives, gelatin, cream, honey, starch, sucrose, mannitol, liquid glucose, and zein.

In some embodiments, factors concerning the liquid interaction, such as the method of introduction of the liquid and the amount of time the liquid interacts with the beverage tablet, may be modified by the beverage machine depending on the type of beverage being prepared, and/or depending on user preferences.

The inventors have appreciated that it may be desirable for beverage tablets to be intentionally broken during a beverage formation process. In some embodiments, beverage tablets may be structurally configured to be broken in a controlled manner. For example, a beverage tablet may be configured to break in a predetermined number of pieces and/or in predetermined shapes. During the brewing process, a beverage tablet may be inserted into a beverage machine and a corresponding beverage method may be selected on the beverage machine. Depending on the brewing process, the beverage tablet may be broken by the machine into a plurality of pieces. In other embodiments, however, the brewing process may keep the beverage tablet intact.

The inventors have appreciated that different breakage events can, in some embodiments, lead to the resulting beverage having varying tastes and/or textures. The inventors have recognized that breakage events can be influenced by the positioning of certain ingredients in specific areas of the tablet. As such, the inventors have found that positioning of certain ingredients in specific areas of the tablet can influence the taste and/or texture of a resulting beverage made from the tablet. In some embodiments, breakage of the beverage tablet may generate different flavor profiles depending on how many pieces the beverage tablet is broken into and/or where breakage occurs in the beverage tablet.

In some embodiments, a beverage tablet may have one or more voids. In some embodiments, such voids may be used to interface with a beverage machine. However, in other embodiments, the voids do not interface with a beverage machine, or may have an additional function other than interfacing with a beverage machine.

In some embodiments, at least one void in a beverage tablet can be configured to be interfaced with a beverage machine to provide breakage of the tablet. For example, the beverage machine may have one or more posts sized to be received in the void(s) of the beverage tablet. In some embodiments, the tablet may have only one void. The void may be of a shape having a finite order of rotational symmetry (e.g., non-circular), which can be beneficial to provide traction between the post of the beverage machine and the void of the tablet.

In some embodiments, void shapes may include, but are not limited to: squares, rectangles, ovals, triangles, trapezoids, rhombuses, crescents, ellipses, pentagons, hexagons, heptagons, octagons, regular polygons, irregular polygons, serpentine shapes, or any other suitable shape having a finite order of rotational symmetry. In some embodiments, the void may be of a concave or convex shape as the disclosure is not limited in this regard. In some embodiments, the post may be actuated as it is interfaced with the void having a finite order of rotational symmetry, resulting in breakage of the tablet. In some embodiments, the at least one void may have a shape with rotational symmetry of order one, two, three, four, five, six, seven, eight, nine, ten, or any other suitable number. As an example, a shape having a rotational symmetry of order two means that the shape looks like its original orientation twice after a full 360 degree rotation. A shape having a rotational symmetry of order three means that the shape looks like its original orientation three times after a full 360 degree rotation. A shape having a rotational symmetry of order one means that the shape looks like its original orientation only once after a full 360 degree rotation.

In some embodiments, the void may be a blind hole extending only partially through, but not entirely through, the body of the tablet. In other embodiments, a void may be a through-hole extending completely through the body of the tablet.

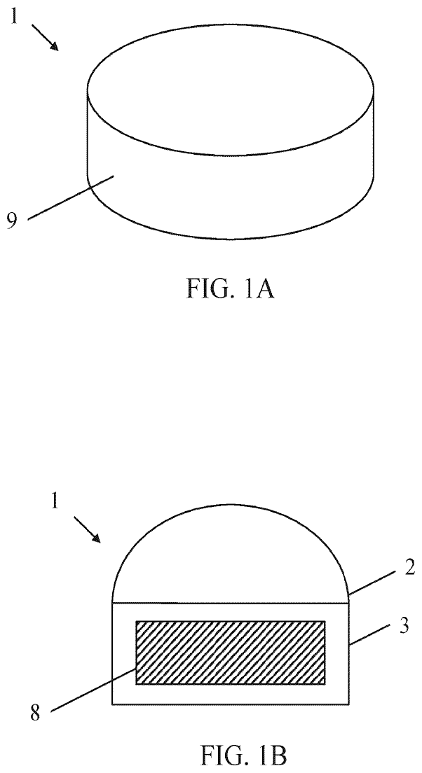

Turning to the figures, illustrative embodiments of various beverage tablets are shown in FIGS. 1A-7B. It should be appreciated that these illustrative embodiments are provided by way of example only, and the inventive aspects herein are not limited to the specific features of these embodiments. Any of the features described above can be applied to any of the illustrative embodiments of the figures as appropriate. Furthermore, any features described in one illustrative embodiment can also be applied to any of the other illustrative embodiments as appropriate.

FIG. 1A shows a perspective view and FIG. 1B shows a perspective cross section view of a beverage tablet 1 having an inner portion 3 and an outer portion 2. The outer portion 2 of may surround at least a majority of a boundary 8 of the inner portion 3. In some embodiments, the outer portion 2 may fully surround the boundary 8 of the inner portion 3. Each of the inner portion 3 and the outer portion 2 can have varying thickness. The thickness of the inner portion 3 and the thickness of the outer portion 2 may be different from one another.

As discussed above, in some embodiments, a concentration of at least one beverage ingredient in the inner portion 3 may be different from the concentration of the beverage ingredient in the outer portion 2 of the beverage tablet. As an example, the beverage tablet may have a different concentration of a binding agent, filter aid and/or type of coffee in the inner portion 3 compared to the outer portion 2 of the tablet.

In some embodiments, the inner portion 3 comprises a coffee having a roast level that is different from a roast level of coffee in an outer portion 2 of the beverage tablet. In some embodiments, the roast level of the coffee in the outer portion may be darker than the roast level of the coffee in the inner portion, or vice versa.

In some embodiments, a binding agent is positioned only in the inner portion 3 of the tablet, and not in the outer portion 2 of the tablet, or vice versa. In some embodiments, the binding agent may be mixed with coffee or any other suitable beverage ingredient.

In one illustrative embodiment, a binding agent is provided at a 10 % wt to coffee ratio, where the binding agent is in the inner portion and the coffee is in the outer portion. Other amounts are contemplated as well. For example, in some embodiments, a binding agent may be provided in a beverage tablet at a percent weight to coffee ratio of: greater than 1%, 2%, 3%, 4%, 5%, 6%, 7%, 8%, 9%, 10%, 11%, 12%, 13%, 14%, 15%, 16%, 17%, 18%, 19%, 20%, or less than 50%, 40%, 30%, 20%, 19%, 18%, 17%, 16%, 15%, 14%, 13%, 12%, 11%, 10%. Ranges of these amounts are contemplated as well. For example, in some embodiments, a binding agent may be provided in an inner portion of a beverage tablet at a percent weight to coffee ratio of: 1 to 50%, 1 to 40%, 1 to 30%, 1 to 25%, 2 to 20%, 3 to 20%, 4 to 20%, 5 to 20%, 6 to 15%, 7 to 15%, or 8 to 15%.

In some embodiments, a filter aid is positioned only in the outer portion 2 of the tablet, and not in the inner portion 3 of the tablet, or vice versa. In some embodiments, the filter aid may be mixed with coffee or any other suitable beverage ingredient.

In the illustrative embodiment of FIGS. 1A and 1B, the tablet has an outer wall 9 in the shape of a circle. However, it should be appreciated that other shapes are possible.

In the illustrative embodiment of FIGS. 1A and 1B, the boundary 8 of the inner portion 3 has a cross-section in the shape of a rectangle. However, it should be appreciated that other shapes are possible.

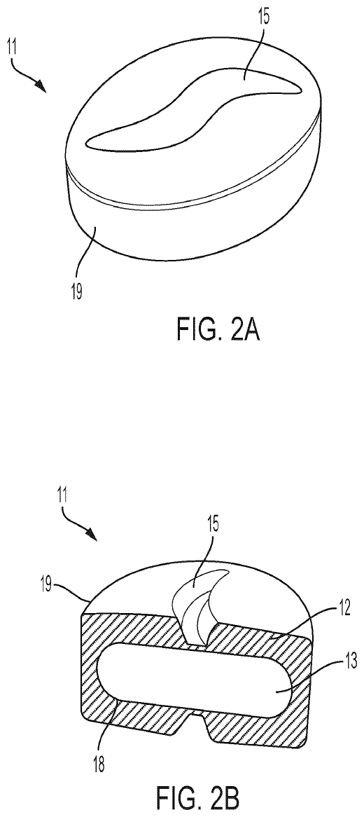

FIGS. 2A and 2B show another embodiment of a beverage tablet 11 having an inner portion 13 and an outer portion 12. In contrast to the beverage tablet of FIGS. 1A and 1B, the beverage tablet 11 has an outer wall 19 in the shape of an oval. Furthermore, the beverage tablet 11 has an inner portion 13 with a cross-section in the shape of a rectangle with rounded corners.

The beverage tablet 11 also includes a void 15 that is a blind hole that extends only partially into the body of the tablet. The void 15 may be a serpentine shape as shown in FIGS. 2A and 2B. It should be appreciated however, that in this and in any other embodiment, voids of any size, shape and number may be provided.

It should be appreciated that any description of beverage tablet features above, including any description pertaining to the beverage tablet of the embodiment of FIGS. 1A and 1B, may also apply to the tablet of FIGS. 2A and 2B.

In the embodiments of FIGS. 1A-2B, the beverage tablets have only a single inner portion. However, it should be appreciated that, in other embodiments, a beverage tablet may have a plurality of inner portions.

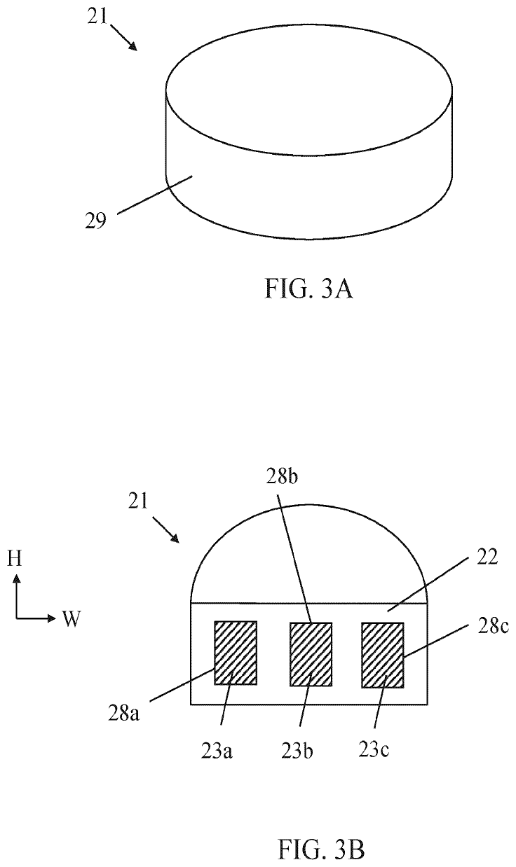

For example, in the alternative embodiment shown in FIGS. 3A and 3B, a beverage tablet 21 may have a plurality of inner portions: a first inner portion 23a, a second inner portion 23b, and a third inner portion 23c, each having a boundary 28a, 28b, 28c, respectively. The tablet 21 may have an outer portion 22 that surrounds each of the outer boundaries 28a, 28b, 28c of the inner portions 23a, 23b, 23c. The inner portions 23a, 23b, 23c of the tablet 21 are positioned side-by-side, spaced from one another along a width direction W.

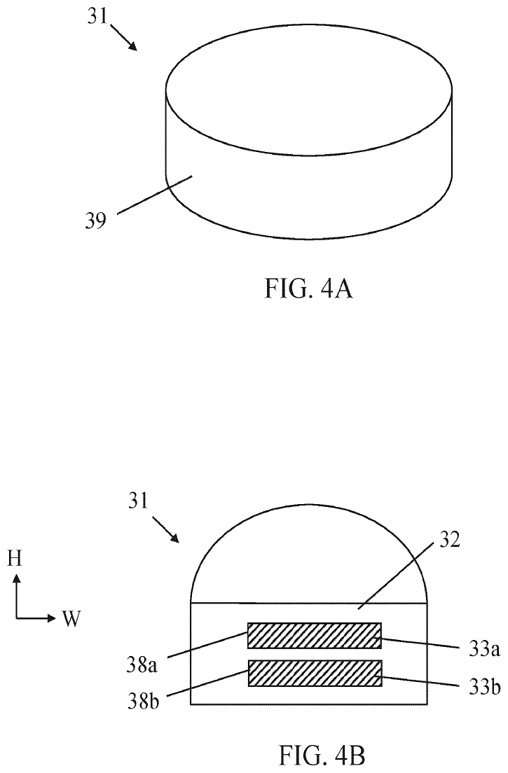

As another example, in the alternative embodiment shown in FIGS. 4A and 4B, a beverage tablet 31 may have a plurality of inner portions: first inner portion 33a and second inner portion 33b, each having a boundary 38a and 38b, respectively. The tablet 31 may have an outer portion 32 that surrounds each of the boundaries 38a, 38b of the inner portions 33a, 33c. The inner portions 23a, 23b, 23c of the tablet 21 are positioned side-by-side, spaced from one another along a height direction H.

It should be appreciated that any description of beverage tablet features above, including any description pertaining to the beverage tablet of any earlier embodiments, may also apply to the tablet of FIGS. 3A and 3B, as well as the tablet of FIGS. 4A and 4B.

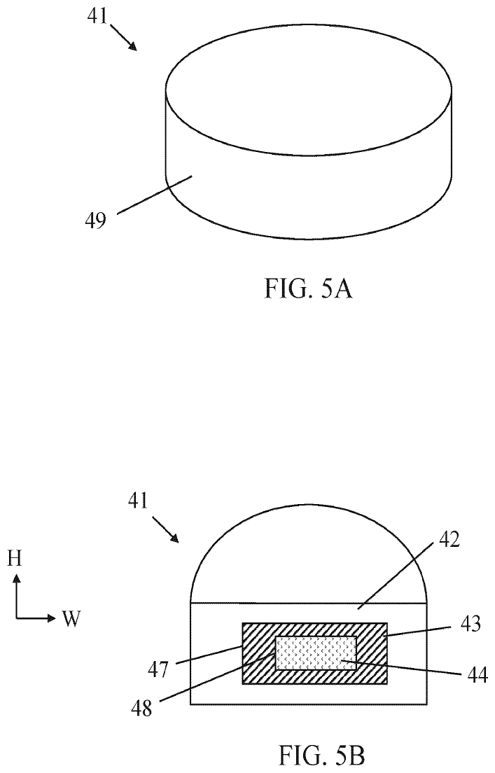

In some embodiments, a beverage tablet may have a plurality of inner portions, where one inner portion is nested within another. For example, as shown in the illustrative embodiments of FIGS. 5A and 5B, a beverage tablet 41 may have an outer portion 42, a first inner portion 43 with a boundary 47, and a second inner portion 44 with a boundary 48. The first inner portion 43 may surround at least a majority of the boundary 48 of the second inner portion 44, and the outer portion 42 may surround at least a majority of the boundary 47 of the first inner portion 43.

It should be appreciated that any description of beverage tablet features above, including any description pertaining to the beverage tablet of any earlier embodiments, may also apply to the tablet of FIGS. 5A and 5B.

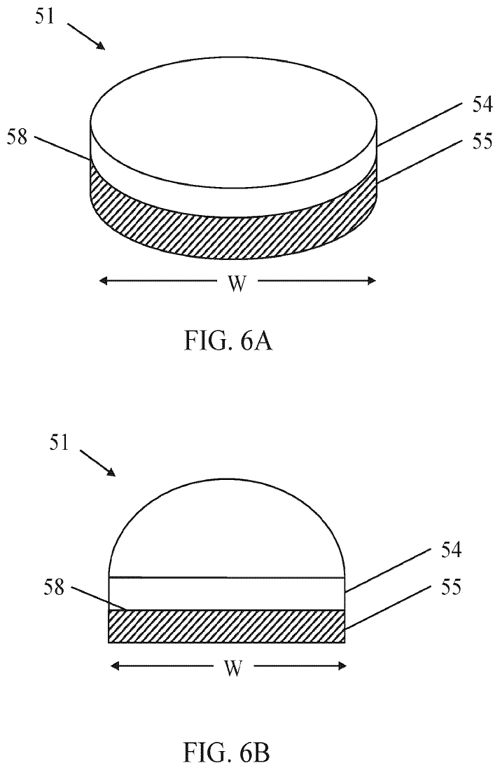

As discussed above, in some embodiments, first and second portions of a beverage tablet may be provided as first and second layers in a beverage tablet. In one illustrative embodiment shown in FIGS. 6A and 6B, a beverage tablet 51 has a layered construction, with a first portion of the tablet forming a first layer 54, and a second portion of the tablet forming a second layer 55. The first and second portions may each span across at least a majority of a width W of the beverage tablet. In the embodiment of FIGS. 6A and 6B, the first and second portions each span across the entirety of the width W of the beverage tablet. In some embodiments, such as the embodiment of FIGS. 6A and 6B, the first and second portions are adjacent to one another, such that there is an interface 58 between the first and second portions. However, it should be appreciated that layers need not be directly adjacent to one another—layers may be separated from one another by other layers and/or by other materials. As discussed above, in some embodiments, a concentration of at least one beverage ingredient in the first layer 54 may be different from the concentration of the beverage ingredient in the second layer 55 of the beverage tablet. As an example, the beverage tablet may have a different concentration of a binding agent, filter aid and/or type of coffee in the first portion 54 compared to the second portion 55 of the tablet.

A layered beverage tablet can be of any shape, such as cuboid, cubic, cylindrical, and/or spherical. The layers of the layered beverage tablet can be of any shape. Although the layers shown in the drawings are planar, it should be appreciated that in other embodiments, the layers need not be planar. For example, a layer of a beverage tablet may be curved upwards at any point of the layer. The layers of the beverage tablet may also be of any thickness, and a layer by itself may not be of uniform thickness. A beverage tablet may be designed such that at least a partial delamination process occurs at the interface between layers during a breakage event.

In some embodiments, an outside surface of a beverage tablet may be embossed with a design. In other embodiments, an outside surface of a beverage tablet may also be unmarked.

It should be appreciated that any description of beverage tablet features above, including any description pertaining to the beverage tablet of the earlier embodiments, may also apply to the tablet of FIGS. 6A and 6B. For example, the teachings related to the composition of the inner portion and the outer portion of the previously discussed embodiments may also apply to the first and second layers of the embodiment of FIGS. 6A and 6B.

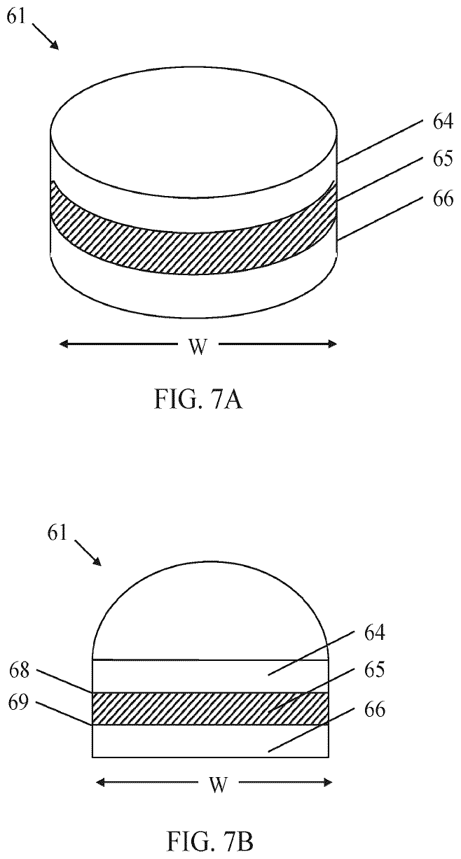

Another illustrative embodiment is shown in FIGS. 7A and 7B. The tablet 61 has three layers: a first layer 64, a second layer 65, and a third layer 66. The two layers 64, 66 may serve as outer layers that sandwich the second layer 65, which may serve as an inner layer. The first, second, and third layers may each span across at least a majority of a width W of the beverage tablet. In the embodiment of FIGS. 7A and 7B, the first, second, and third layers each span across the entirety of the width W of the beverage tablet. In some embodiments, such as the embodiment of FIGS. 7A and 7B, the first and second layers are adjacent to one another, such that there is an interface 68 between the first and second layers. The second the third layers may be adjacent to one another, such that there is an interface 69 between the second the third layers. However, it should be appreciated that layers need not be directly adjacent to one another—layers may be separated from one another by other layers and/or by other materials.

In some embodiments, a concentration of at least one beverage ingredient in the first layer 64 may be different from the concentration of the beverage ingredient in the second layer 65 of the beverage tablet. As an example, the beverage tablet may have a different concentration of a binding agent, filter aid and/or type of coffee in the first layer 64 compared to the second layer 65 of the tablet.

In some embodiments, the first layer 64 and third layer 66 may be similar to one another—that is, they may be made of similar concentrations of beverage ingredients, while being different from the inner layer 65.

In some embodiments, the inner layer 65 comprises a coffee having a roast level that is different from a roast level of coffee in the outer layers 64, 66 of the beverage tablet. In some embodiments, the roast level of the coffee in the outer layers may be darker than the roast level of the coffee in the inner layer, or vice versa. In some embodiments, combining one or more layers of darker roast coffee with one or more layers of lighter roast coffee in a single beverage tablet may serve to increase the tensile strength of the tablet compared to a tablet made only of the lighter roast coffee.

In some embodiments, a binding agent is positioned only in the inner layer 65 of the tablet, and not in the outer layers 64, 66 of the tablet, or vice versa. In some embodiments, the binding agent may be mixed with coffee or any other suitable beverage ingredient.

In some embodiments, a filter aid is positioned only in the outer layers 64, 66 of the tablet, and not in the inner layer 65 of the tablet, or vice versa. In some embodiments, the filter aid may be mixed with coffee or any other suitable beverage ingredient.

In some embodiments, a beverage tablet may include more than three layers.

It should be appreciated that any description of beverage tablet features above, including any description pertaining to the beverage tablet of the earlier embodiments, may also apply to the tablet of FIGS. 7A and 7B. For example, the teachings related to the composition of the inner portion and the outer portion of the previously discussed embodiments may also apply to the layers of the embodiment of FIGS. 7A and 7B.

As discussed above, in some embodiments, the loose beverage ingredients from first and second (or more) portions of a beverage tablet may be co-compressed with one another during formation of the beverage tablet. In some embodiments, the loose beverage ingredients of each portion may be introduced into a die cavity, and compressed together within the die cavity such that the ingredients are co-compressed. (In other words, this is in contrast to individually compressing each portion separately, and then bringing the already-compressed portions together and compressing them). This co-compression process may be used to form beverage tablets having an outer portion and one or more inner portions as discussed above. This co-compression process may also be used to form beverage tablets having a layered structure as discussed above.

In other embodiments, however, it should be appreciated that portions may be first individually compressed separately and then brought together and compressed to form a beverage tablet.

As discussed above, the inventors have found that positioning certain ingredients in specific areas of a beverage tablet may result in unique tablet breakage profiles. A conventional compacted tablet subjected to a diametral compression force will typically break into two roughly equal primary pieces (very small particles, e.g. crumbs, may not be considered a primary piece). However, by positioning certain ingredients in specific areas of a beverage tablet, e.g. such that the concentration of a beverage ingredient in a first portion of the tablet is different from the concentration of the beverage ingredient in a second portion of a tablet, a tablet may be configured to break differently. In some embodiments, a beverage tablet may be configured such that a first portion will delaminate from a second portion along an interface between the two portions during a breakage event. For example, an outer portion may delaminate from an inner portion during a breakage event, which may cause the outer portion to flake off of the inner portion and break into a plurality of pieces.

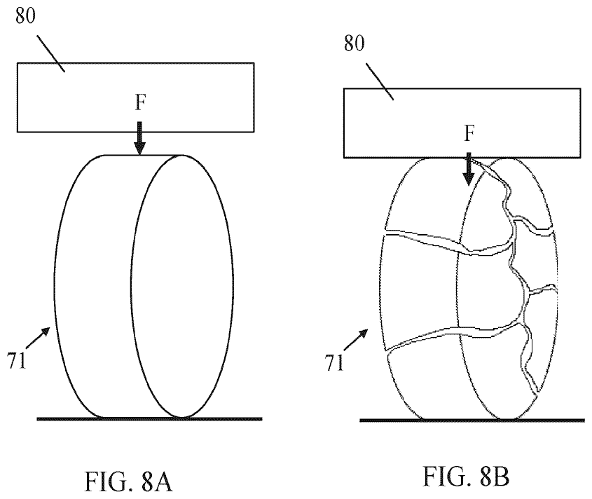

FIGS. 8A and 8B illustrate a beverage tablet according to aspects described herein undergoing diametral compression, e.g. by a compression test machine, or by a beverage machine. A force F is applied to a tablet 71 by a machine 80. In response to the applied force F, the tablet 71 breaks into a plurality of primary pieces. In the illustrative embodiment shown in FIG. 8B, the tablet breaks into approximately 6 primary pieces. However, in other embodiments, the tablet may break into any suitable number of primary pieces, such as at least 3, at least 4, at least 5, at least 6, at least 7, at least 8, at least 9, at least 10, at least 11, at least 12, at least 13, at least 14, at least 15 or any other suitable number of primary pieces.

The embodiments disclosed herein may be combined in any suitable arrangement as the disclosure is not limited in this regard. While the present teachings have been described in conjunction with various embodiments and examples, it is not intended that the present teachings be limited to such embodiments or examples. On the contrary, the present teachings encompass various alternatives, modifications, or equivalents, as will be appreciated by those of skill in the art. Accordingly, the foregoing description is by way of example only.

1. A beverage tablet for use in forming a beverage, the tablet comprising:
an inner portion comprising a first ingredient, the first ingredient comprising coffee, and the inner portion having a boundary; and
an outer portion surrounding at least a majority of the boundary of the inner portion, the outer portion comprising a second ingredient, the second ingredient comprising coffee,
wherein the first ingredient has a roast level that is different from a roast level of the second ingredient.

2. The beverage tablet of claim 1, wherein the outer portion fully surrounds the boundary of the inner portion.

3. The beverage tablet of claim 1, wherein the roast level of the first ingredient is lighter than the roast level of the second ingredient.

4. The beverage tablet of claim 1, wherein the inner portion has a tensile strength that is different than a tensile strength of the outer portion.

5. The beverage tablet of claim 4, wherein the tensile strength of the inner portion is higher than the tensile strength of the outer portion.

6. The beverage tablet of claim 1, wherein the first ingredient and the second ingredient are co-compressed during formation of the beverage tablet.

7. The beverage tablet of claim 1, wherein the outer portion is configured to delaminate from the inner portion in response to a diametral compression force.

8. The beverage tablet of claim 1, wherein the inner portion further comprises a binding agent, wherein a concentration of the binding agent in the inner portion is greater than a concentration of the binding agent in the outer portion.

9. The beverage tablet of claim 8, wherein the binding agent comprises cellulose.

10. The beverage tablet of claim 1, wherein the outer portion further comprises a filter aid, wherein a concentration of the filter aid in the outer portion is greater than a concentration of the filter aid in the inner portion.

11. The beverage tablet of claim 10, wherein the filter aid comprises cellulose.

12. The beverage tablet of claim 1, wherein the beverage tablet further comprises an outer wall having a shape with a finite order of rotational symmetry.

13. The beverage tablet of claim 12, wherein the outer wall is non-circular.

14. The beverage tablet of claim 12, wherein the outer wall is oval-shaped.

15. The beverage tablet of claim 1, wherein the beverage tablet further comprises an outer wall having a circular shape.

16. The beverage tablet of claim 1, further comprising a second inner portion having a boundary, wherein the outer portion surrounds at least a majority of the boundary of the second inner portion, and wherein the second inner portion is nested within the inner portion.

17. The beverage tablet of claim 1, further comprising a second inner portion having a boundary, wherein the outer portion surrounds at least a majority of the boundary of the second inner portion, and wherein the second inner portion is spaced from the inner portion.

18. A beverage tablet for use in forming a beverage, the tablet comprising:
a first portion of the beverage tablet made of one or more beverage ingredients; and
a second portion of the beverage tablet made of one or more beverage ingredients,
wherein a concentration of a filter aid is greater in the second portion than in the first portion.

19-34. (canceled)

35. A beverage tablet for use in forming a beverage, the tablet comprising:
a first portion of the beverage tablet made of one or more beverage ingredients; and
a second portion of the beverage tablet made of one or more beverage ingredients,
wherein a concentration of a binding agent is greater in the first portion than in the second portion.

36-52. (canceled)

53. A method of manufacturing a beverage tablet comprising:
introducing a first beverage ingredient into a die cavity;
introducing a second beverage ingredient into the die cavity; and
compressing the first and second beverage ingredients together within the die cavity such that the first and second beverage ingredients are co-compressed.

54-56. (canceled)
